(19) United States
(12) Patent Application Publication
(10) Pub. No.: US 2003/0023958 A1
(43) Pub. Date: Jan. 30, 2003

(54) Intermediate language accelerator chip

(76) Inventors: Mukesh K. Patel, Fremont, CA (US); Dan Hillman, San Jose, CA (US); Jay Kamdar, Cupertino, CA (US); Jon Shiell, San Jose, CA (US); Udaykumar R. Raval, Santa Clara, CA (US)

Correspondence Address: Joseph P. O'Malley, BURNS, DOANE, SWECKER & MATHIS, L.L.P., P.O. Box 1404, Alexandria, VA, 22313-1404, US

(21) Appl. No.: 10/187,858

(22) Filed: Jun. 27, 2002

Related U.S. Application Data
(60) Provisional application No. 60/306,376, filed on Jul. 17, 2001.

(51) Int. Cl. G06F 9/45

(52) U.S. Cl. 717/146

(57) ABSTRACT

An accelerator chip can be positioned between a processor chip and a memory. The accelerator chip enhances the operation of a Java program by running portions of the Java program for the processor chip. In a preferred embodiment, the accelerator chip includes a hardware translator unit and a dedicated execution engine.

### RELATED APPLICATIONS

The present application is related to application Ser. No. 60/306,376 filed Jul. 17, 2001, which is incorporated herein by reference.

### BACKGROUND OF THE INVENTION

Java™ is an object-orientated programming language developed by Sun Microsystems. The Java language is small, simple and portable across platforms and operating systems, both at the source and binary level. This makes the Java programming language very popular on the Internet.

Java's platform independence and code compaction are the most significant advantages of Java over conventional programming languages. In conventional programming languages, the source code of a program is sent to a compiler which translates the program into machine code or processor instructions. The processor instructions are native to the system's processor. If the code is compiled on an Intel-based system, the resulting program will run only on other Intel-based systems. If it is desired to run the program on another system, the user must go back to the original source code, obtain a compiler for the new processor, and recompile the program into the machine code specific to that other processor.

Java operates differently. The Java compiler takes a Java program and, instead of generating machine code for a specific processor, generates bytecodes. Bytecodes are instructions that look like machine code, but are not specific to any processor. To execute a Java program, a bytecode interpreter takes the Java bytecodes and converts them to equivalent native processor instructions and executes the Java program. The Java bytecode interpreter is one component of the Java Virtual Machine (JVM).

Having the Java programs in bytecode form means that instead of being specific to any one system, the programs can be run on any platform and any operating system as long as a Java Virtual Machine is available. This allows a binary bytecode file to be executable across platforms.

The disadvantage of using bytecodes is execution speed. System-specific programs that run directly on the hardware from which they are compiled run significantly faster than Java bytecodes, which must be processed by the Java Virtual Machine. The processor must both convert the Java bytecodes into native instructions in the Java Virtual Machine and execute the native instructions.

Poor Java software performance, particularly in embedded system designs, is a well-known issue and several techniques have been introduced to increase performance. However these techniques introduce other undesirable side effects. The most common techniques include increasing system and/or microprocessor clock frequency, modifying a JVM to compile Java bytecodes and using a dedicated Java microprocessor.

Increasing a microprocessor's clock frequency results in overall improved system performance gains, including performance gains in executing Java software. However, frequency increases do not result in one-for-one increases in Java software performance. Frequency increases also raise power consumption and overall system costs. In other words, clocking a microprocessor at a higher frequency is an inefficient method of accelerating Java software performance.

Compilation techniques (e.g., just in time “JIT” compilation) contribute to erratic performance because the speed of software execution is delayed during compilation. Compilation also increases system memory usage because compiling and storing a Java program consumes an additional five to ten times the amount of memory over what is required to store the original Java program.

Dedicated Java microprocessors use Java bytecode instructions as their native language, and while they execute Java software with better performance than typical commercial microprocessors they impose several significant design constraints. Using a dedicated Java microprocessor requires the system design to revolve around it and forces the utilization of specific development tools usually only available from the Java microprocessor vendor. Furthermore, all operating system software and device drivers must be custom developed from scratch because commercial software of this nature does not exist.

It is desired to have an embedded system with improved Java software performance.

### SUMMARY OF THE PRESENT INVENTION

One embodiment of the present invention comprises a system including at least one memory, a processor chip operably connected to the one memory, and an Accelerator Chip. The memory access for the processor chip to at least one memory being sent through the Accelerator Chip. The Accelerator Chip has direct access to the at least one memory. The Accelerator Chip is adapted to run at least portions of programs using intermediate language instructions. The intermediate language instructions include Java bytecodes and also include the intermediate language forms of other interpreted languages. These intermediate language forms include Multos bytecodes, UCSD Pascal P-codes, MSIL for C#/.NET and other instructions. While the present invention is for any intermediate language, Java will be referred to for examples and clarification.

By using an Accelerator Chip, systems with conventional processor chips and memory units can be accelerated for processing intermediate language instructions such as Java bytecodes. The Accelerator Chip is preferably placed in the path between the processor chip and the memory and can run intermediate language programs very efficiently. In a preferred embodiment, the Accelerator Chip includes a translator unit which translates at least some intermediate language instructions and an execution engine to execute the translated instructions. Execution of multiple intermediate languages can be supported in one accelerator concurrently or sequentially. For example, in one embodiment, the accelerator executes Java bytecodes as well as MSIL for C#/.NET.

Another embodiment of the present invention comprises an Accelerator Chip including a unit to execute intermediate language instructions, such as Java bytecodes and a memory interface. The memory interface is adapted to allow for memory access for the Accelerator Chip to at least one memory and to allow memory access to a separate processor chip to the at least one memory. By having an Accelerator Chip with such a memory interface, the Accelerator Chip can be placed in the path between the processor chip and memory unit.

Another embodiment of the present invention comprises an Accelerator Chip including a hardware translator unit, an execution engine, and a memory interface.

In another embodiment of the present invention, an intermediate language instruction cache operably connected to the hardware translator unit is used. By storing the intermediate language instructions in the cache, the execution speed of the programs can be significantly improved.

Another embodiment of the present invention comprises an Accelerator Chip including a hardware translator unit adapted to convert intermediate language instructions into native instructions, and a dedicated execution engine, the dedicated execution engine adapted to execute native instructions provided by the hardware translator unit. The dedicated execution engine only executing instructions provided by the hardware translator unit. The hardware translator unit rather than the execution engine preferably determines the address of the next intermediate language instructions to translate and provide to the dedicated execution engine. Alternatively the execution engine can determine the next address for the intermediate language instructions.

In one embodiment, the hardware translator unit only translates some intermediate language instructions, other intermediate language instructions cause a callback to the processor chip that runs a virtual machine to handle these exceptional instructions.

### BRIEF DESCRIPTION OF THE DRAWINGS

FIG. 1 is a diagram illustrating a system of one embodiment of the present invention.

FIG. 2 is a diagram illustrating an Accelerator Chip of one embodiment of the present invention.

FIG. 3 is a diagram of another embodiment of a system of the present invention.

FIG. 4A is a state machine diagram illustrating the modes of an Accelerator Chip of one embodiment of the present invention.

FIG. 4B is a state machine diagram illustrating modes of an accelerator chip of another embodiment of the present invention.

FIG. 5 is a table illustrating a power management scheme of one embodiment of an Accelerator Chip of the present invention.

FIG. 6 is a table illustrating one example of a list of bytecodes executed by an Accelerator Chip and a list of bytecodes that cause the callbacks to the processor chip for one embodiment of the system of the present invention.

FIG. 7 is a diagram that illustrates a common system memory organization for the memory units that can be used with one embodiment of the system of the present invention.

FIG. 8 is a table of pin functions for one embodiment of an Accelerator Chip of the present invention.

FIG. 9 is a diagram that illustrates memory wait states for different access times through the accelerator chip or without the accelerator chip for one embodiment of the present invention.

FIG. 10 is a high level diagram of an accelerator chip of one embodiment of the present invention.

FIG. 11 is a diagram of a system in which the accelerator chip interfaces with SRAMs.

FIG. 12 is a diagram of an accelerator chip in which the accelerator chip interfaces with SDRAMs.

FIG. 13 is a diagram of a system with an accelerator chip that has a larger bit interface to the memory than with the system on a chip.

FIG. 14 is a diagram of an accelerator chip including a graphics acceleration engine interconnected to an LCD display.

FIG. 15 is a diagram that illustrates the use of an accelerator chip within a chip stack package such that pins need not be dedicated for the interconnections to a flash memory and an SRAM.

FIG. 16A is a diagram of new instructions for one embodiment of the acceleration engine of one embodiment of the present invention.

FIGS. 16B-16E illustrate the operation of the new instructions of FIG. 16A.

FIG. 17 is a diagram of one embodiment of an execution engine illustrating the logic elements for the new instructions of FIG. 16A.

FIG. 18A is a diagram that illustrates a Java bytecode instruction.

FIG. 18B illustrates a conventional microcode to implement the Java bytecode instruction.

FIG. 18C indicates the microcode with the new instructions of FIG. 16A to implement the Java bytecode instruction of FIG. 18A.

FIG. 19A illustrates the Java bytecode instruction LCMP.

FIG. 19B illustrates the conventional microcode for implementing the LCMP Java bytecode instruction of FIG. 19A.

FIG. 19C illustrates the microcode with the new instructions implementing the Java bytecode instruction LCMP of FIG. 19A.

### DETAILED DESCRIPTION OF THE PREFERRED EMBODIMENT

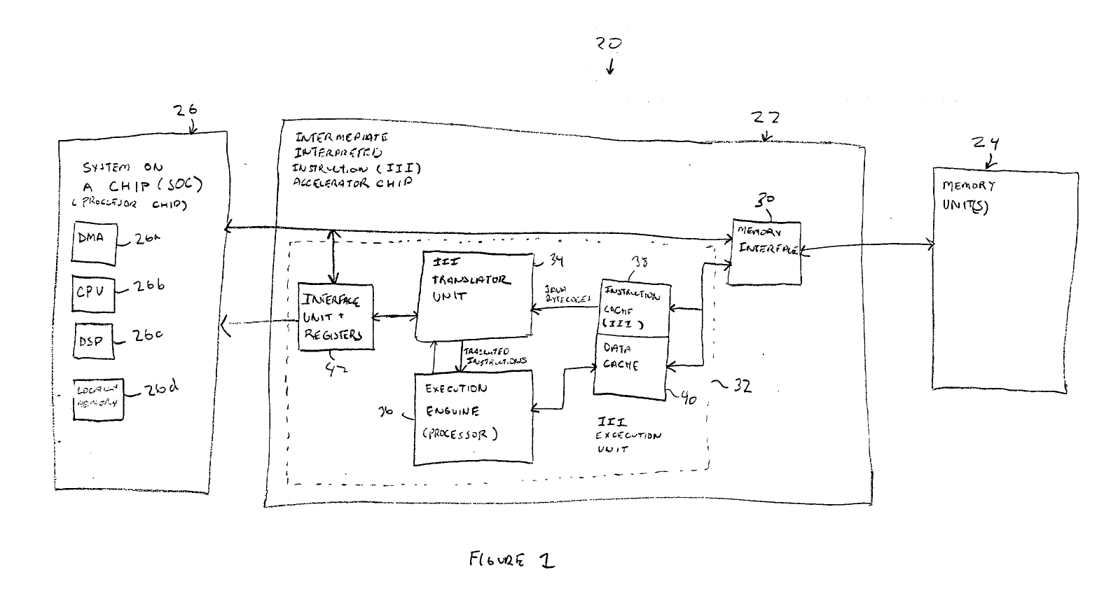

FIG. 1 illustrates a system 20 of one embodiment of the present invention. In this embodiment, an Accelerator Chip 22 is positioned between a processor chip 26 and memory units 24. Typically, a processor chip 26 interfaces with memory units 24. This is especially common in embedded systems used for communications, cell phones, personal digital assistants, and the like. In one embodiment the processor chip is a system on a chip (SOC) including a large variety of elements. For example, in one embodiment the processor chip 26 includes a direct memory access unit (DMA) 26a, a central processing unit (CPU) 26b, a digital signal processor unit (DSP) 26c and local memory 26d. In one embodiment, the SOC is a baseband processor for cellular phones for a wireless standard such as GSM, CDMA, W CDMA, GPRS, etc.

As will be described below, the Accelerator Chip 22 is preferably placed within the path between the processor chip 26 and memory units 24. The Accelerator Chip 22 runs at least portions of programs, such as Java, in an accelerated manner to improve the speed and reduce the power consumption of the entire system. In this embodiment, the Accelerator Chip 22 includes an execution unit 32 to execute intermediate language instructions, and a memory interface unit 30. The memory interface unit 30 allows the execution unit 32 on the Accelerator Chip 22 to access the intermediate language instructions and data to run the programs. Memory interface 30 also allows the processor chip 26 to obtain instructions and data from the memory units 24. The memory interface 30 allows the Accelerator Chip to be easily integrated with existing chip sets (SOC's). The accelerator function can be integrated as a whole or in part on the same chip stack package or on the same silicon with the SOC. Alternatively, it can be integrated into the memory as a chip stack package or on the same silicon.

The execution unit portions 32 of the Accelerator Chip 22 can be any type of intermediate language instruction execution unit. For example, in one embodiment a dedicated processor for the intermediate language instructions, such as a dedicated Java processor, is used.

In a preferred embodiment, however, the intermediate language instruction execution unit 32 comprises a hardware translator unit 34 which translates intermediate language instructions into translated instructions for an execution engine 36. The hardware translator unit 34 efficiently translates a number of intermediate language instructions. In one embodiment, the processor chip 26 handles certain intermediate language instructions which are not handled by the hardware translator unit. By having the translator unit efficiently translate some of the intermediate language instructions, then having these translated instructions executed by an execution engine, the speed of the system can be significantly increased. The translator can be microcode based, hence allowing the microcode to be swapped for Java versus C#/.NET.

Running a virtual machine completely in the processor 26 has a number of disadvantages. The translation portion of the virtual machine interpreter tends to be quite large and can be larger than the caches used in the processor chips. This causes the portions of the translating code to be repeatedly brought in and out of the cache from external memory, which slows the system. The translator unit 34 on the Accelerator Chip 22 does the translation without requiring translation software transfer from an external memory unit. This can significantly speed the operation of the intermediate language programs.

The use of callbacks for some intermediate language instructions is useful because it can reduce the size and power consumption of the Accelerator Chip 22. Rather than having a relatively complicated execution unit that can execute every intermediate language instruction, translating only certain intermediate language instructions in the translation unit 34 and executing them in the execution engine 36 reduces the size and power consumption of the Accelerator Chip 22. The intermediate language instructions executed by the accelerator are preferably the most commonly used instructions. The intermediate language instructions not executed by the accelerator chip can be implemented as callbacks such that they are executed on the SoC. Alternatively, the Accelerator Chip of one embodiment can execute every intermediate language instruction.

Also shown in the execution unit 32 of one embodiment is an interface unit and registers 42. In a preferred embodiment, the processor chip 26 runs a modified virtual machine which is used to give instructions to the Accelerator Chip 22. When a callback occurs, the translator unit 34 sets a register in unit 42 and the execution unit restores all the elements that need restoring and indicates such in the unit 42. In a preferred embodiment, the processor chip 26 has control over the Accelerator Chip 22 through the interface unit and registers 42. The execution unit 32 operates independently once the control is handed over to the Accelerator Chip.

In a preferred embodiment, an intermediate language instruction cache 38 is used associated with the translator unit 34. Use of an intermediate language instruction cache further speeds up the operation of the system and results in power savings because the intermediate language instructions need not be requested as often from the memory units 24. The intermediate language instructions that are frequently used are kept in the instruction cache 38. In a preferred embodiment, the instruction cache 38 is a two-way associative cache. Also associated with the system is a data cache 40 for storing data.

Although the translator unit is shown in FIG. 1 as separate from the execution engine, the translator unit can be incorporated into the execution engine. In that case, the central processing unit (CPU) or execution engine has a hardware translator subunit to translate intermediate language instructions into the native instructions operated on by the main portion of the CPU or the execution engine.

The intermediate language instructions are preferably Java bytecodes. Note that other intermediate language instructions, such as Multos bytecodes, MSIL, BREW, etc., can be used as well. For simplicity, the remainder of the specification describes an embodiment in which Java is used, but other intermediate language instructions can be used as well.

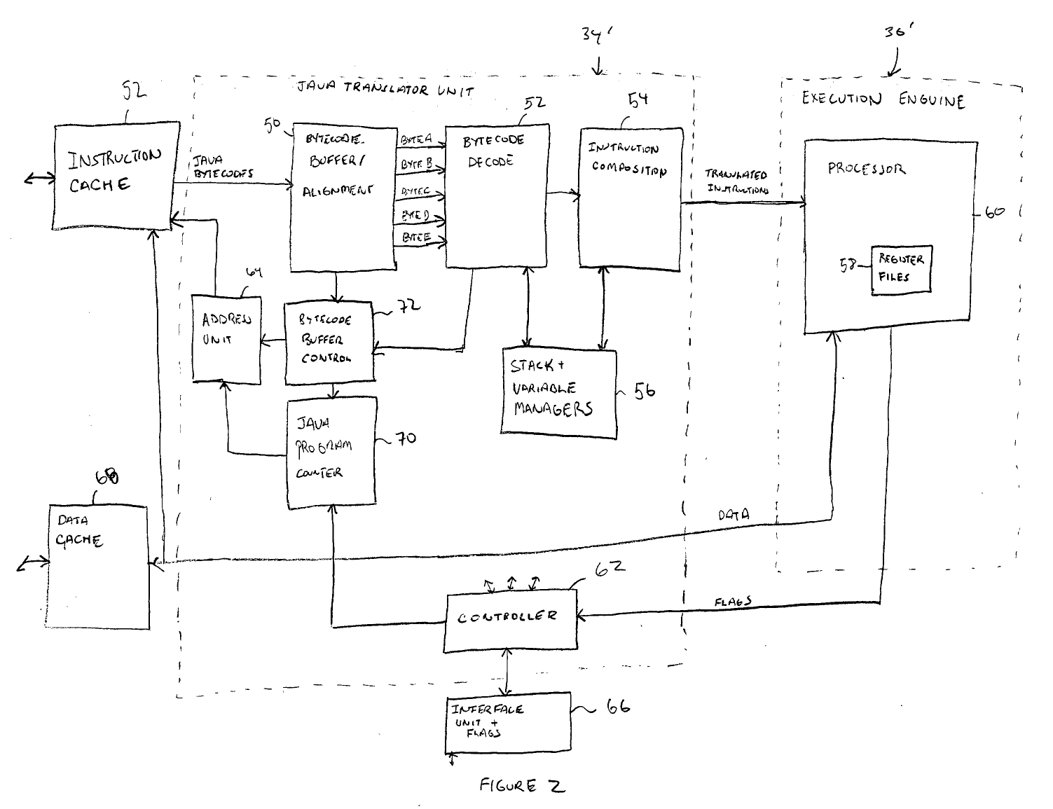

FIG. 2 is a diagram of one embodiment of an Accelerator Chip. In this embodiment, the Java bytecodes are stored in the instruction cache 52. These bytecodes are then sent to the Java translator 34′. A bytecode buffer alignment unit 50 aligns the bytecodes and provides them to the bytecode decode unit 52. In a preferred embodiment, for some bytecodes, instruction level parallelism is done with the bytecode decode unit 52 combining more than one Java bytecode into a single translated instruction. In other situations, the Java bytecode results in more than one native instruction as required. The Java bytecode decode unit 52 produces indications which are used by the instruction composition unit 54 to produce translated instructions. In a preferred embodiment, a microcode lookup table unit associated with or within unit 54 produces the base portion of the translated instructions with other portions provided from the Stack and Variable Managers 56 which keep track of the meaning of the locations in the register file 58 of the processor 60 in execution engine 36′. In one embodiment, the register file 58 of the processor 60 stores the top eight Java operand stack values, sixteen Java variable values and four scratch values.

In a preferred embodiment, the execution engine 36′ is dedicated to only execute the translated instructions from the Java translating unit. In a preferred embodiment, processor 60 is a reduced instruction set computing (RISC) processor or a DSP, or VLIW or CISC processor. These processors can be customized or modified so its instruction set is designed to efficiently execute the translated instructions. Instructions and features that are not needed are preferably removed from the instruction set of the execution engine to produce a simpler execution engine—for example, interrupts are preferably not used. Furthermore, the execution engine 36′ need not directly calculate the location of the next instruction to execute. The Java translator unit 34′ can instead calculate the addresses of the next Java bytecode to translate. The processor 60 produces flags to controller 62 which then calculates the location of the next Java bytecode to translate. Alternatively, standard processors can be used.

In one embodiment, the bytecode buffer control unit 72 checks how many bytecode bytes are accepted into the Java translator, and modifies the Java program counter 70. The controller 62 can also modify the Java program counter. The address unit 64 obtains the next instruction either from the instruction cache or from external memory. Note that, for example, the controller 62 can also clear out the Java translator unit's pipeline if required by a “branch taken” or a callback. Data from the processor 60 is also stored in the data cache 68.

When the virtual machine modifies the bytecode to the quick form, the cache line in the hardware accelerator holding the bytecode being modified needs to be invalidated. The same is true when the virtual machine reverses this process and restores the bytecode to the original form. Additionally, the callbacks invalidate the appropriate cache line in the instruction cache using a cache invalidate register in the interface register.

In some embodiments, when quick bytecodes are used, the modified instructions are stored back into the instruction cache 52. When quick bytecodes are used, the system must keep track of how the Java bytecodes are modified and eventually have instruction consistency between the cache and the external memory.

In one embodiment, the decoded bytecodes from the bytecode decode unit are sent to a state machine unit and Arithmetic Logic Unit (ALU) in the instruction composition unit 54. The ALU is provided to rearrange the bytecode instructions to make them easier to be operated on by the state machine and perform various arithmetic functions including computing memory references. The state machine converts the bytecodes into native instructions using the lookup table. Thus, the state machine provides an address which indicates the location of the desired native instruction in the microcode look-up table. Counters are maintained to keep a count of how many entries have been placed on the operand stack, as well as to keep track of and update the top of the operand stack in memory and in the register file. In a preferred embodiment, the output of the microcode look-up table is augmented with indications of the registers to be operated on in the register file. The register indications are from the counters and interpreted from bytecodes. To accomplish this, it is necessary to have a hardware indication of which operands and variables are in which entries in the register file. Native Instructions are composed on this basis. Alternately, these register indications can be sent directly to the register file.

In another embodiment of the present invention, the Stack and Variable manager assigns Stack and Variable values to different registers in the register file. An advantage of this alternate embodiment is that in some cases the Stack and Var values may switch due to an Invoke Call and such a switch can be more efficiently done in the Stack and Var manager rather than producing a number of native instructions to implement this.

In one embodiment, a number of important values can be stored in the hardware accelerator to aid in the operation of the system. These values stored in the hardware accelerator help improve the operation of the system, especially when the register files of the execution engine are used to store portions of the Java stack.

The hardware translator unit preferably stores an indication of the top of the stack value. This top of the stack value aids in the loading of stack values from the memory. The top of the stack value is updated as instructions are converted from stack-based instructions to register-based instructions. When instruction level parallelism is used, each stack-based instruction which is part of a single register-based instruction needs to be evaluated for its effects on the Java stack.

In one embodiment, an operand stack depth value is maintained in the hardware accelerator. This operand stack depth indicates the dynamic depth of the operand stack in the execution engine register files. Thus, if eight stack values are stored in the register files, the stack depth indicator will read “8.” Knowing the depth of the stack in the register file helps in the loading and storing of stack values in and out of the register files.

Additionally, a frame stack can be maintained in the hardware with its own underflow/overflow and frame depth indication to indicate how many frames are on the frame stack. The frame stack can be a stand-alone stack or incorporated within the CPU's register file. In a preferred embodiment, the frame stack and the operand stack can be within the same register file of the CPU. In another embodiment, the frame stack and the operand stack are different entities. The local variables would also be stored in a separate area of the CPU register file which also has the operand stack and/or the frame stack.

In a preferred embodiment, a minimum stack depth value and a maximum stack depth value are maintained by the hardware translator unit. The stack depth value is compared to the required maximum and minimum stack depths. When the stack value goes below the minimum value, the hardware translator unit composes load instructions to load stack values from the memory into the register file. When the stack depth goes above the maximum value, the hardware translator unit composes store instructions to store stack values back out to the memory.

In one embodiment, at least the top eight (8) entries of the operand stack in the execution engine register file operate as a ring buffer, and the ring buffer is maintained in the accelerator and is operably connected to a overflow/underflow unit.

The hardware translator unit also preferably stores an indication of the operands and variables stored in the register file of the execution engine. These indications allow the hardware accelerator to compose the converted register-based or native instructions from the incoming stack-based instructions.

The hardware translator unit also preferably stores an indication of the variable base and operand base in the memory. This allows for the composing of instructions to load and store variables and operands between the register file of the execution engine and the memory. For example, when a variable (Var) is not available in the register file, the hardware issues load instructions. The hardware is adapted to multiply the Var number by four and adding the Var base to produce the memory location of the Var. The instruction produced is based on knowledge that the Var base is in a temporary native execution engine register. The Var number times four can be made available as the immediate field of the native instruction being composed, which may be a memory access instruction with the address being the content of the temporary register holding a pointer to the Vars base plus an immediate offset. Alternatively, the final memory location of the Var may be read by the execution engine as an instruction and then the Var can be loaded.

In one embodiment, the hardware translator unit marks the variables as modified when updated by the execution of Java bytecodes. The hardware accelerator can copy variables marked as modified to the system memory for some bytecodes.

In one embodiment, the hardware translator unit composes native instructions wherein the native instruction's operands contain at least two native execution engine register file references where the register file contents are the data for the operand stack and variables.

In one embodiment a stack-and-variable-register manager maintains indications of what is stored in the variable and stack registers of the register file of the execution engine. This information is then provided to the decode stage and microcode stage in order to help in the decoding of the Java bytecode and generating appropriate native instructions.

In a preferred embodiment, one of the functions of a Stack-and-Var register manager is to maintain an indication of the top of the stack. Thus, if for example registers R1-R4 store the top 4 stack values from memory or by executing bytecodes, the top of the stack will change as data is loaded into and out of the register file. Thus, register R2 can be the top of the stack and register R1 be the bottom of the stack in the register file. When a new data is loaded into the stack within the register file, the data will be loaded into register R3, which then becomes the new top of the stack, the bottom of the stack remains R1. With two more items loaded on the stack in the register file, the new top of stack in the register file will be R1 but first R1 will be written back to memory by the accelerator's overflow/underflow unit, and R2 will be the bottom of the partial stack in the register file.

FIG. 3 shows the main functional units within an example of an accelerator chip accelerator as well as how it interfaces into a typical wireless handset design. The accelerator chip integrates between the host microprocessor (or the SOC that includes an embedded microprocessor) and the system SRAM and/or Flash memory. From the perspective of the host microprocessor and system software, the system SRAM and/or Flash memory is behind the accelerator chip.

The Accelerator Chip has direct access to the system SRAM and/or Flash memory. The host microprocessor (or microprocessor within an SOC) has transparent access to the system SRAM or Flash memory through the Accelerator Chip (“the system memory is behind the accelerator”).

The Accelerator Chip preferably synchronizes with the host microprocessor via a monitor within its companion software kernel. The Software Kernel (or the processor chip) loads specific registers in the accelerator chip with the address of where Java bytecode instructions are located, and then transfers control to the accelerator chip to begin executing. The software kernel then waits in a polling loop running on the host microprocessor reading the run mode status until either it detects that it is necessary to process a bytecode using the callback mechanism or until all bytecodes have been executed. The polling loop can be implemented by reading the “run mode” pin electrically connected between the accelerator chip and a general purpose I/O pin on the SOC. Alternatively, the same status of the “run mode” can be polled by reading the registers within the accelerator chip. In either of these cases, the accelerator chip automatically enters its power-saving sleep state until callback processing has completed or it is directed to execute more bytecodes.

The Accelerator Chip fetches the entire Java bytecode including the operands from memory, through its internal caches, and executes the instruction. Instructions and data resident in the caches are executed faster and at reduced power consumption because system memory transactions are avoided. Bytecode streams are buffered and analyzed prior to being interpreted using an optimizer based on instruction level parallelism (ILP). The ILP optimizer coupled with locally cached Java data results in the fastest execution possible for each cycle.

Since the Accelerator Chip is a separate stand-alone Java bytecode execution engine, it processes concurrently while the host microprocessor is either waiting in its polling loop or processing interrupts. Furthermore, the Accelerator Chip is only halted during instances when the host microprocessor needs to access system memory behind it, and the accelerator chip also wants to access system memory at the same time. For example, if the host microprocessor is executing an interrupt service routine or other software from within its own cache, then the Accelerator Chip can concurrently execute bytecodes. Similarly, if Java bytecode instructions and data reside within the Accelerator Chip's internal caches, then the accelerator can concurrently execute bytecodes even if the host microprocessor needs to access system memory behind it.

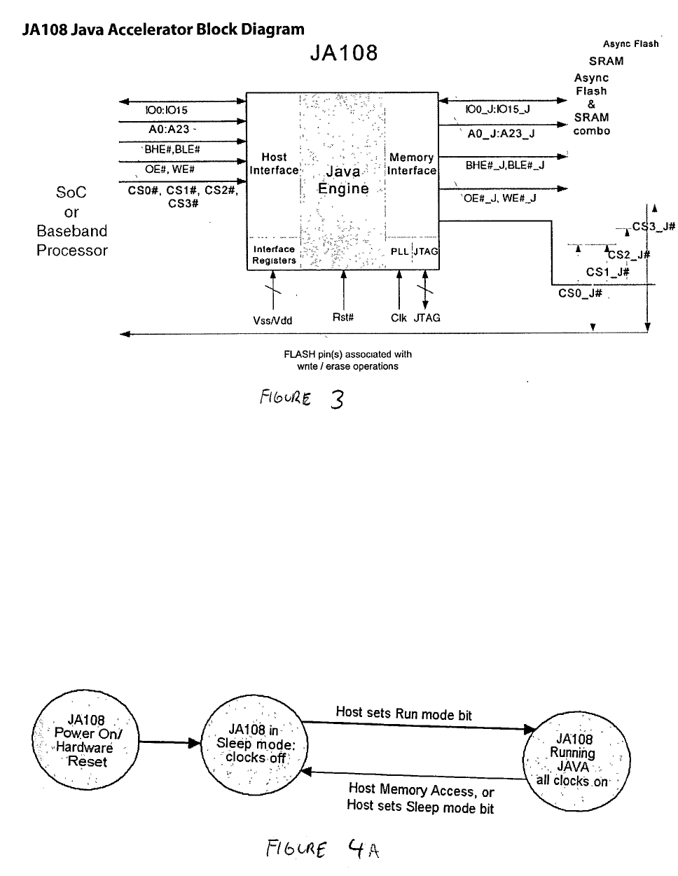

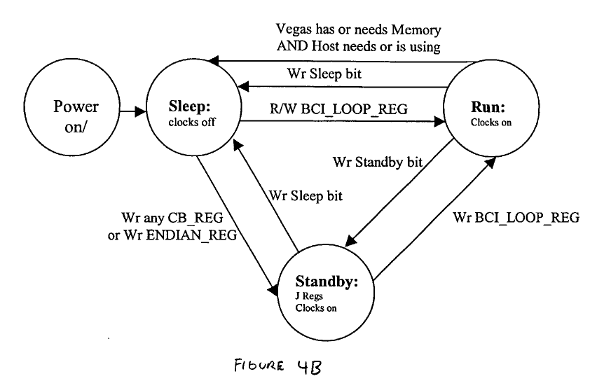

FIG. 4A is a state machine showing the two primary modes of the accelerator chip of one embodiment: sleep and running (executing Java bytecode instructions). The accelerator chip automatically transitions between its running and sleep states. In its sleep state, the accelerator chip draws minimal power because the Java engine core and associated components are idled.

FIG. 4B is a diagram of the states of the accelerator chip of another embodiment of the system of the present invention, further including a standby mode. The standby mode is used during callbacks. In order to reduce power, only the clocks to the Java registers are on. In the standby mode, the processor chip is running the virtual machine to handle the Java bytecode that causes the callback. Since the accelerator chip is in the standby mode, it can quickly recover without having to reset all of the Java registers.

FIG. 5 shows what components are active and idle in each mode of the state machine of FIG. 4A. When the JVM is not running or when the system determines that additional power savings are appropriate, the Accelerator Chip automatically assumes its sleep mode.

Once activated, the Accelerator Chip runs until any of the following events occurs:

1. When it is necessary that a Java bytecode instruction be executed by the host microprocessor via the software callback mechanism.

2. The host microprocessor needs to access system memory, which typically only occurs during interrupt and exception processing.

3. The host microprocessor halts the accelerator chip by forcing it into its sleep mode.

The Accelerator Chip is disabled (in its sleep mode) and transparent to all native resident software by default, and it is enabled when a modified Java virtual machine initializes it and calls on it to execute Java bytecode instructions. When the accelerator chip is in its sleep mode, accesses to SRAM or Flash memory from the host microprocessor simply pass through the Accelerator chip.

The Accelerator Chip includes a memory controller as an integral part of its memory interface circuitry that needs to be programmed in a manner typical of SRAM and/or Flash memory controllers. The actual programming is done within the software kernel with the specific memory addresses set according to each device's unique architecture and memory map. As part of the modified Java virtual machine's initialization sequence, registers within accelerator chip are loaded with the appropriate information. When the system calls on its JVM to execute Java software, it first loads the address of the start of the Java bytecodes into the Java Program Counter (JP) of the Accelerator Chip. The kernel then begins running on the host microprocessor monitoring the Accelerator Chip for when it signals that it has completed executing Java bytecodes. Upon completion the Accelerator Chip goes into its sleep mode and its kernel returns control to the JVM and the system software.

The Accelerator chip does not disturb interrupt or exception processing, nor does it impose any latency. When an interrupt or exception occurs while the Accelerator Chip is processing, the host microprocessor diverts to an appropriate handler routine without affecting accelerator chip. Upon return from the handler, the host microprocessor returns execution to the software kernel and in turn resumes monitoring the Accelerator Chip. Even when the host microprocessor takes over the memory bus, the Accelerator Chip can continue executing Java bytecodes from its internal cache, which can continue so long as a system memory bus conflict does not arise. If a conflict arises, a stall signal can be asserted to halt the accelerator.

The Accelerator Chip has several shared registers that are located in its memory map at a fixed offset from a programmable base. The registers control its operation and are not meant for general use, but rather are handled by code within the Software Kernel.

Referring to FIG. 3, it can be seen that the Accelerator Chip is positioned between the host microprocessor (or the SOC that includes an embedded microprocessor) and the system SRAM and/or Flash memory. All system memory accesses by the host microprocessor therefore pass through the Accelerator Chip. In one embodiment, while fully transparent to all system software, a latency of approximately 4 nanoseconds is introduced for each direction, contributing to a total latency of approximately 8 nanoseconds for each system memory transaction.

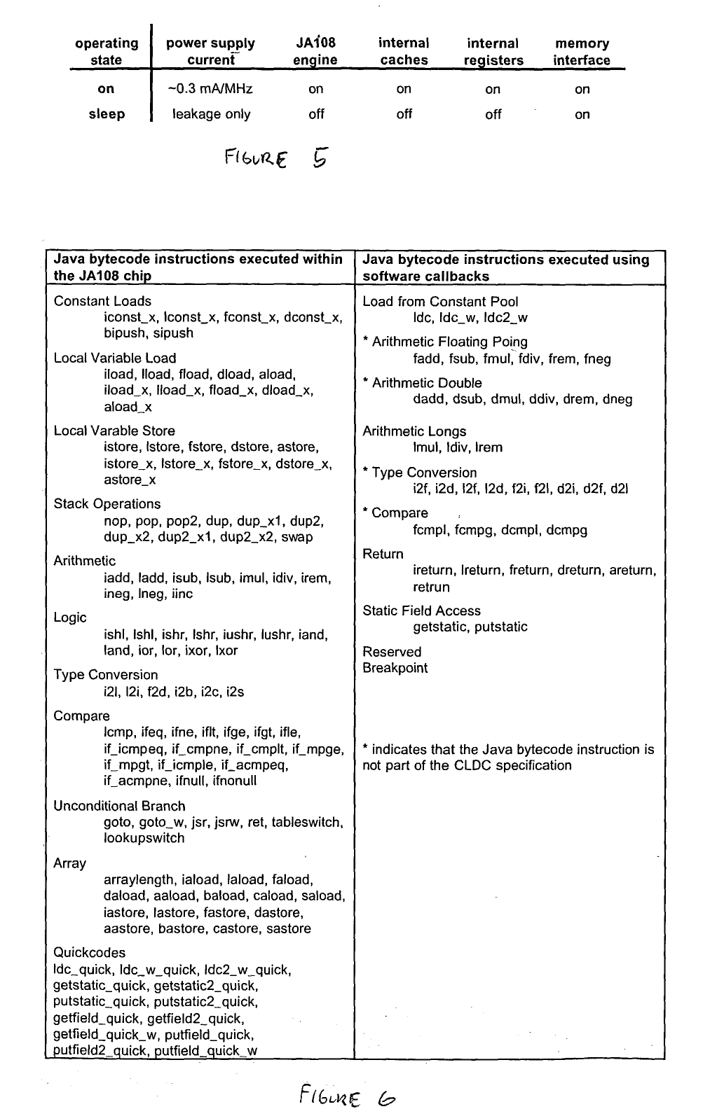

FIG. 6 is a table that illustrates one embodiment of a list of Java bytecodes that are executed by the Java execution unit on the Accelerator Chip and a list of bytecodes that cause a callback to the modified JVM running on the processor chip. Note that the most common bytecodes are executed on the Accelerator Chip. Other less common and more complex bytecodes are executed in software on the processor chip. By excluding certain Java bytecodes from the Accelerator Chip, the Accelerator Chip complexity and power consumption can be reduced.

FIG. 7 illustrates a typical memory organization and the types of software and data that can be stored in each type of memory. Placement of the items listed in the table below allows the accelerator chip to access the bytecodes and corresponding data items necessary for it to execute Java bytecode instructions.

The operating system running on the host microprocessor is preferably set up such that virtual memory equals real memory for all areas of memory that the accelerator chip will access as part of its Java processing.

Integration with a Java virtual machine is preferably accomplished through the modifications as listed below.

1. Insertion of modified initialization code into the JVM's own initialization sequence.

2. Removal of the Java bytecode interpreter and installing the modified software kernel. This includes redirecting the functionality for the Java bytecode instructions that are not directly executed within the accelerator chip hardware into the callback mechanism enabled by the accelerator chip software kernel. Additionally, for quick bytecodes, when the JVM modifies the bytecode to its quick form, the cache line within the Hardware Accelerator instruction cache holding the bytecode being modified (“quickified”) must be invalidated. The same is true when JVM reverses this process and restores the bytecode to its original form. The accelerator chip and its software kernel preferably provide Application Programming Interface (API) calls to handle these situations.

3. Adapting the garbage collector. The JVM's garbage collector invalidates the data cache within the accelerator chip before scanning the Java Heap or Java Stack to avoid cache coherency problems. This is preferably accomplished using an API function within the Software Kernel.

One embodiment of the Accelerator Chip preferably interfaces with any system that has been designed with asynchronous SRAM and/or asynchronous Flash memory including page mode Flash memory. In such circumstances, the accelerator chip easily integrates because it looks to the system like an SRAM or Flash device. No other accommodations are necessary for integration. The Accelerator Chip has its own memory controller and correspondingly the ability to access memory “behind the accelerator” directly via an internal program counter (IPC). As with any program counter, the JP points to the address of the next instruction to be fetched and executed. This allows the accelerator chip to operate asynchronously and concurrently with regard to the host microprocessor.

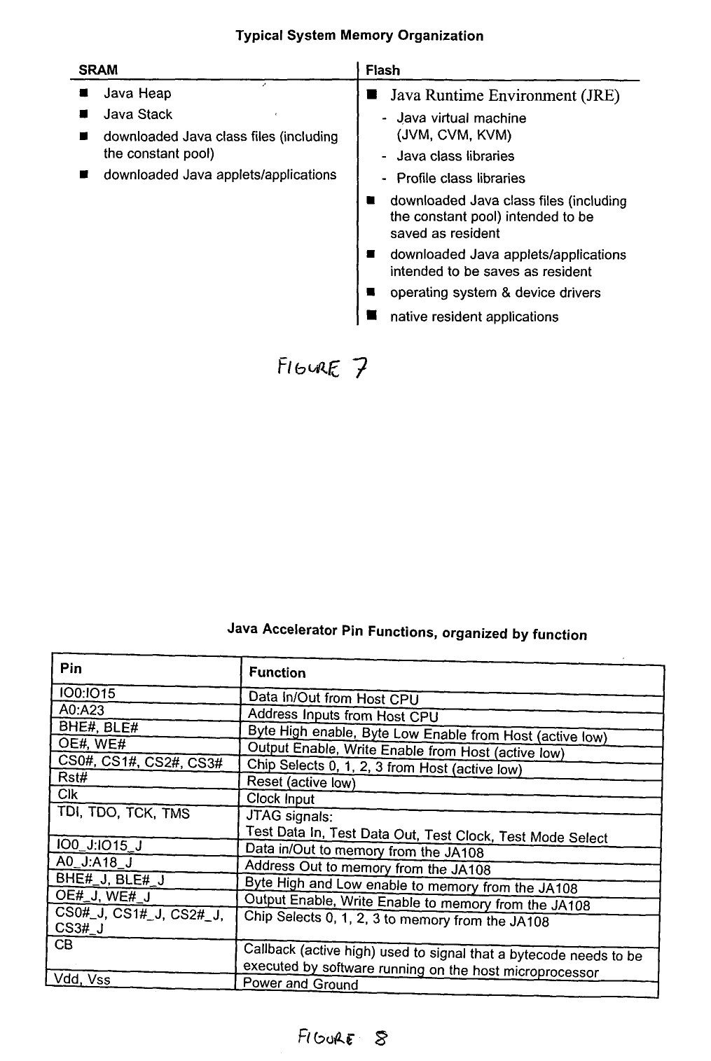

FIG. 8 is a table that illustrates on example of the accelerator pin functions for one example of an Accelerator Chip of the present invention.

In a preferred embodiment, the pins going to the processor chip and going to the memory are located near each other in order to keep the delay through the chip at the minimum for the bypass mode.

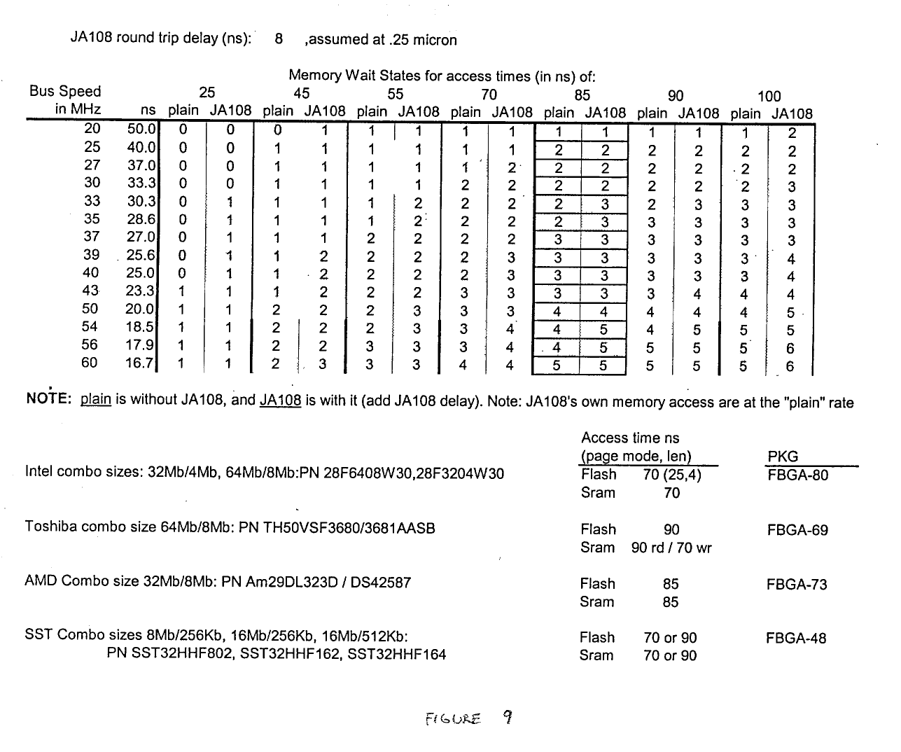

FIG. 9 is a diagram that illustrates the wait states for different access times and bus speeds with an embodiment of a hardware accelerator positioned in between the processor chip, such as an SOC, and the memory. Note that in some cases, additional wait states for access times need to be added due to the introduction of the hardware accelerator in the path between the processor chip and the memory.

FIG. 10 is a diagram of a hardware accelerator of one embodiment of the present invention. The hardware accelerator 100 includes bypass logic 102. This connects to the system on a chip interface 104 and memory interface 106. The memory controller 108 is interconnected to the interface register 110 which is used to send messages between the system on the chip and the hardware accelerator. Instructions going through the memory controller 108 to the instruction cache 112 and the data from the data cache 114 are sent to the memory controller 108. The intermediate language instructions from an instruction cache 112 are sent to the hardware translator 114, which translates them to native instructions, and sends the translated instructions to the execution engine 116. In this embodiment, the execution engine 116 is broken down into a register read stage 116A, an execution stage 116B and a data cache stage 116C.

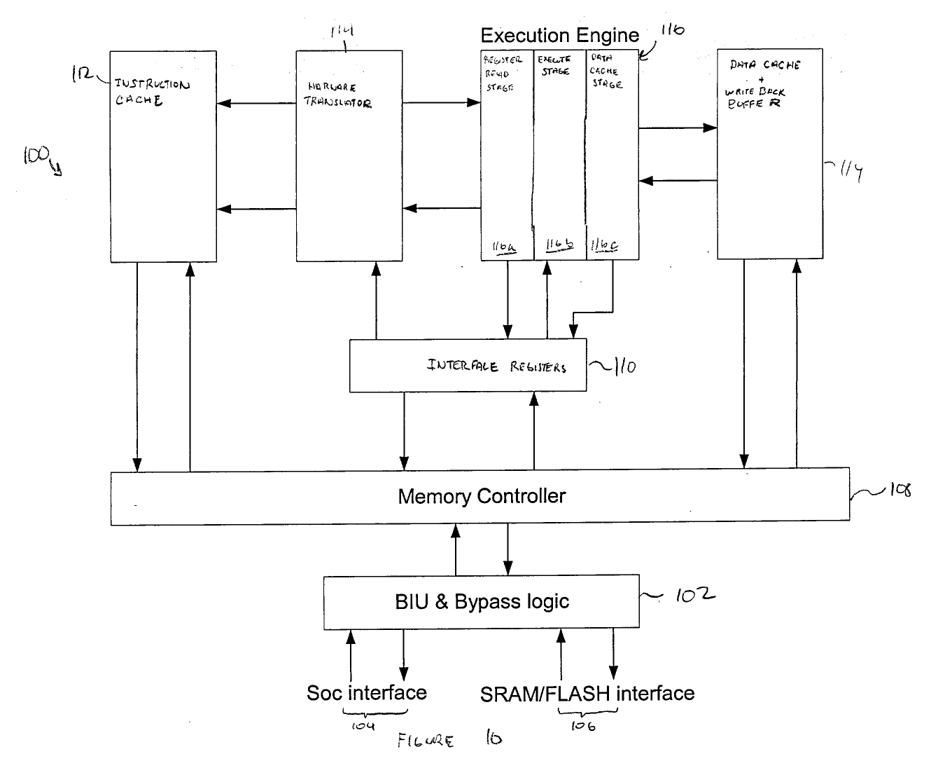

FIG. 11 is a diagram of a hardware accelerator 120 which is used to interface with SRAM memories. Since SRAM memories and SDRAM memories can be significantly different, in one embodiment, there is a dedicated hardware accelerator for each type of memory. FIG. 11 shows the hardware accelerator including an instruction cache, hardware translator, data cache, execution engine, a phase lock loop (PLL) circuit which is used to set the internal clock of the hardware accelerator such that it is synched to an external clock, the interface registers and SRAM slave interface and SRAM master interface. The SRAM slave interface interconnecting to the system on a chip, and SRAM master interface interconnecting to the memory. The diagram of FIG. 11 emphasizes the fact that the connections between the system on a chip and the memory are separate and dealt with separate interfaces. Thus, interactions between the hardware accelerator and the system on a chip and interactions between the hardware accelerator and the memory can be done concurrently for independent operations. Shown interconnected between the system on a chip and the hardware accelerator are address lines, data lines, byte select lines, write enable lines, read enable lines, chip select lines and the like. Note that the asynchronous flash pins can go directly between the processor chip and the asynchronous flash unit. The hardware accelerator chip can modify the chip selection memory addressing capabilities of the system on a chip. In one embodiment, an optional system on a chip memory is stored in the SRAM slave interface. The host processor enters a wait loop to check the run mode set by the interface register of the hardware accelerator. The system on a chip obtains the register loop check program from the SRAM slave interface. The hardware accelerator 120 is not interrupted by the SOC accessing the loop program in the external memory and, thus, can more efficiently run the intermediate language programs stored in the external memory. Note that the hardware accelerator 120 can include a JTAG test unit.

FIG. 12 illustrates an embodiment of the system of the present invention in which the hardware accelerator 130 includes an SDRAM slave and SDRAM master interfaces. The control lines for interconnecting to an SDRAM are significantly different from the control lines interconnecting to an SRAM so that it makes sense to have two different versions of the hardware accelerator in one embodiment. Additional lines for the SDRAM include a row select, column select and write enable lines.

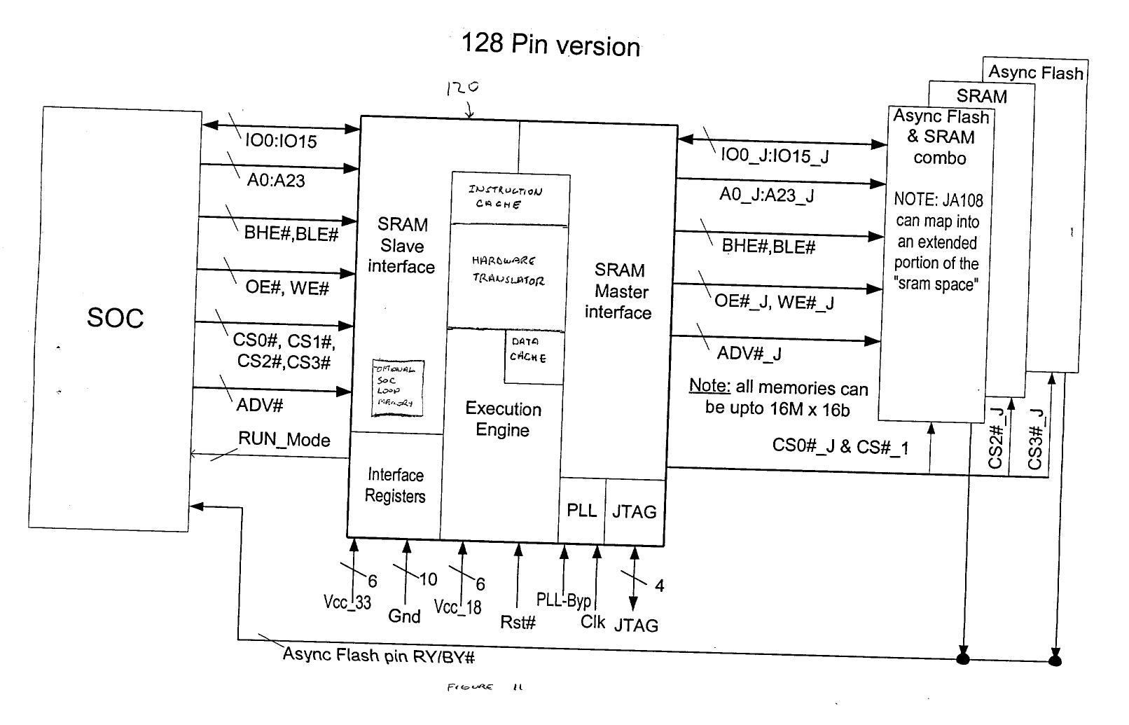

FIG. 13 illustrates a diagram of a host hardware accelerator 140. This embodiment has a 16-bit interconnection from the processor chip and a 32-bit connection between the hardware accelerator 140 and the memory. The interconnection between the memory and the hardware accelerator will operate faster than the interconnection between the processor and the memory. A host burst buffer is included in the host accelerator 140 such that data can be buffered between the processor chip and the memory.

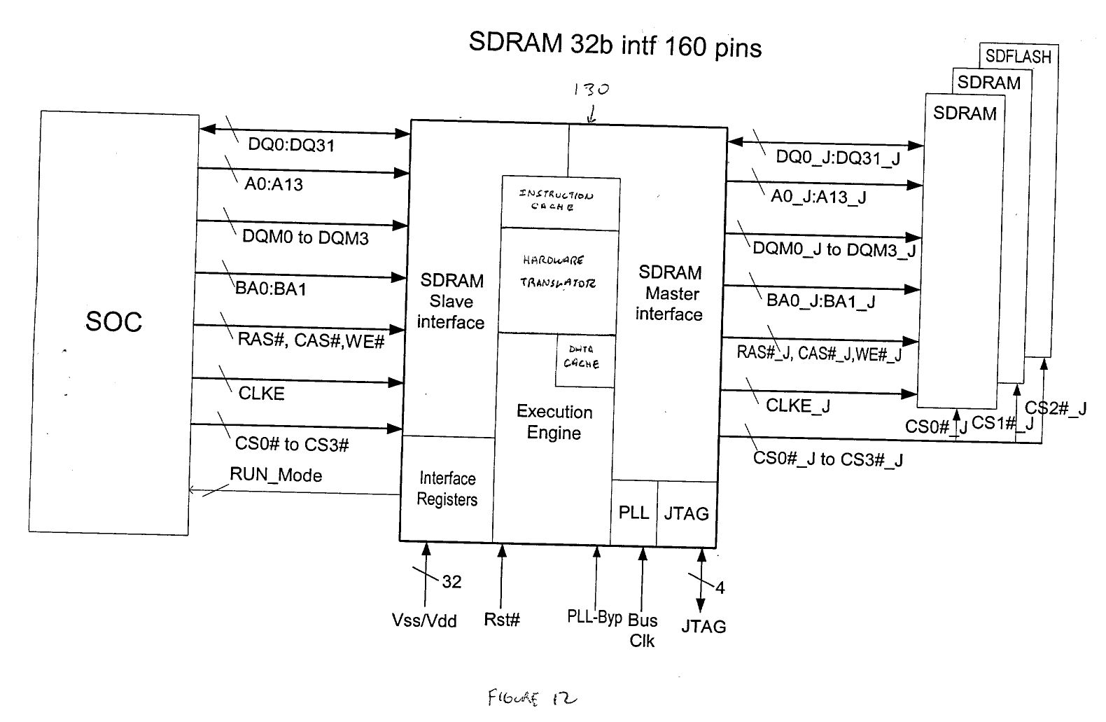

FIG. 14 illustrates an embodiment in which the hardware accelerator 150 includes a graphics accelerator engine 152 and an LCD controller and display buffers 154. This allows the hardware accelerator 150 to interact with the LCD display 156 in a direct manner. The Java standards include a number of libraries. These libraries are typically implemented such that devices can run a different type of code other than Java code to implement them. One new type of library includes graphics for LCD display. For example, a canvas application is used for writing applications that need to handle low-level events and issue graphical calls for drawing on the LCD display. Such an application would typically be used for games and the like. In the embodiment of FIG. 14, a graphics accelerator engine 152 and LCD control and display buffer engines 154 are placed in the hardware accelerator 150, so the control of the system need not be passed to the processor chip. Whenever a graphics element is to be run, a Java program rather than the conventional program is used. The Java program stored in the memory is used to update the LCD display 156. In one embodiment, the Java program uses a special identifier bytecode which is used by the hardware accelerator 150 to determine that the program is for LCD graphics acceleration engine 152. It is not always necessary to have the LCD controller on the same chip if the function is available on the SOC. In this case, only the graphics would still be on the accelerator. The graphics can be for 2D as well as 3D graphics. Additionally, a video camera interface can also be included on the chip. The camera interface unit would interface to a video unit where the video image size can be scaled and/or color space conversion can be applied. By setting certain registers within the accelerator chip it is possible to merge video and graphics to provide certain blend and window effects on the display. The graphics unit would have its own frame buffer and optionally a Z-buffer for 3D. For efficiency, it would be optimal to have the graphics frame buffer in the accelerator chip and have the Z-buffer in the system SRAM or system SDRAM.

FIG. 15 is a diagram of a chip stack package 160 which includes an accelerator chip 162, flash chip 164 and SRAM chip 166. By putting the accelerator chip 162 in a package along with the memory chips 164 and 166, the number of pins that need to be dedicated on the package for interconnecting between the accelerator chip and the memory can be reduced. In the example of FIG. 15, the reduction in the number of pins allows a set of pins to be used for a bus data and addresses to an auxiliary memory location. Positioning the accelerator chip on the same package as the flash memory chip and SRAM chip also reduces the memory access time for the system.

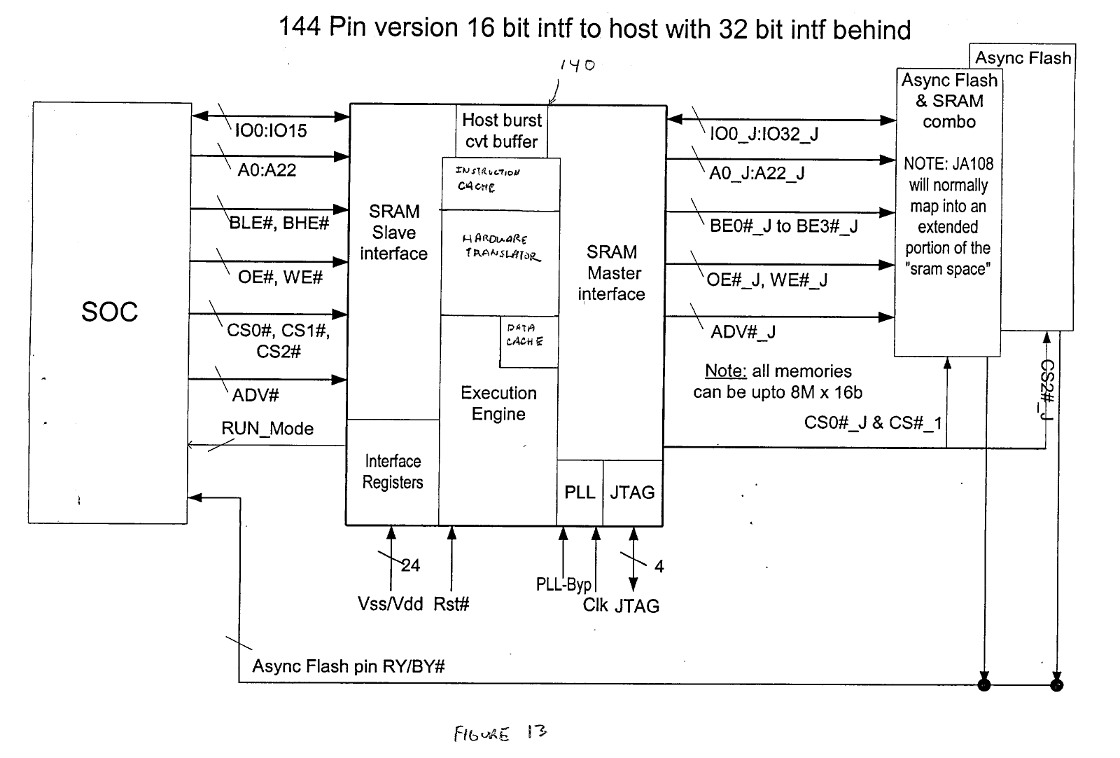

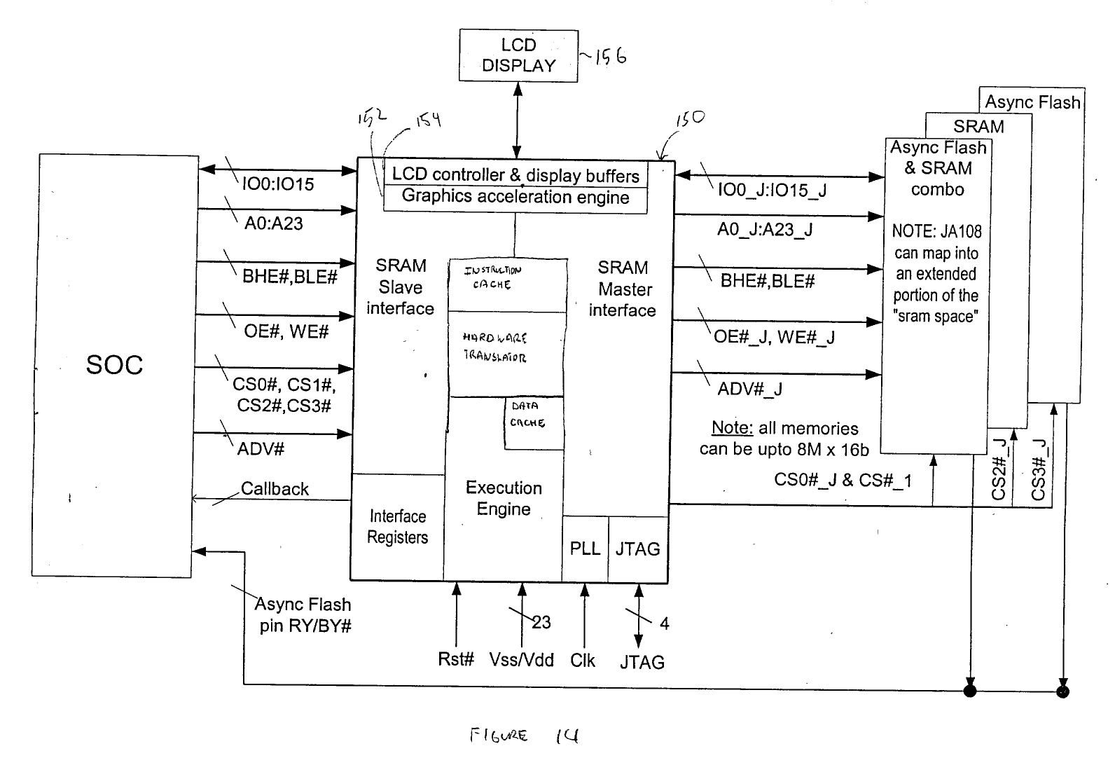

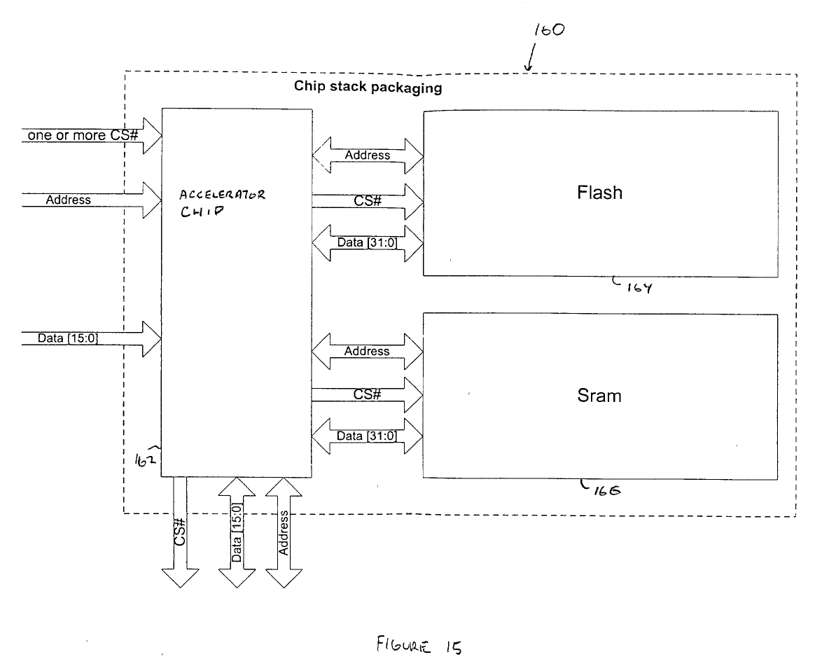

FIGS. 16-19 are diagrams that illustrate new instructions which are useful for adding to the accelerator engine of one embodiment of the present invention, so that it efficiently executes translated intermediate language instructions, especially Java bytecodes. The embodiment of FIGS. 16-19 can be used within a hardware accelerator chip, but can also be used with other systems using a hardware translator and an execution engine.

FIG. 16A illustrates new instructions for an execution engine that speeds up the operation of translated instructions. By having these translated instructions, the operation of the execution engine running the translated instructions can be improved. The instructions SGTLT0 and SGTLT0U use the C, N and Z outputs of the adder/subtractor of a previous operation in order to then write a −1, 0 or 1 in a register. These operations improve the efficiency of the Java bytecode LCMP. The bounds check operation (BNDCK) and the load and store index instructions with the register null check speed the operation of the translated instructions for the Java bytecodes that do indexed array access.

FIG. 16B illustrates the operation of the instruction SGTLT0. When the last subtract or add produces a Z bit of 1, the output into the register is a 0. When the previous Z bit is a 0, and the N bit is a 0, the output into the register is a 1. When the Z bit is 0, and the N bit is a 1, the output into the register is a −1.

FIG. 16C illustrates the instruction SGTLT0U, in which an unsigned operation is used. In this example, if the Z value is high, the output to the register is a 0. If the Z value is low, and the carry is a 0, the output to the register is −1. If the Z value is low, and the carry is 1, the output to the register is 1.

FIG. 16D illustrates the bound check instruction BNDCK. In this instruction, the index is subtracted from the array size value. If the index is greater than the array size, the carry will be 1, and an exception will be created. If the index is less than the array size, the carry will be 0, and no exception will be produced.

FIG. 16E shows indexed instructions, including the index loads and index stores that check a register for a null value, in addition to the index operation. In this case, if the array pointer register is a 0, an exception occurs. If the array pointer is not a 0, no exception occurs.

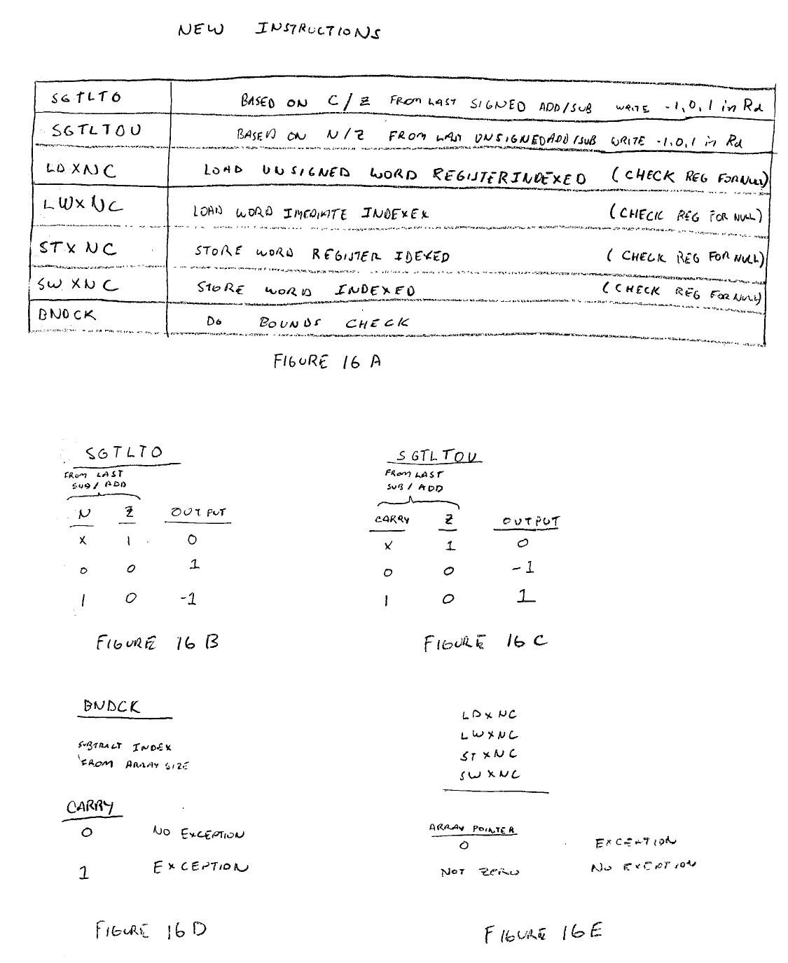

FIG. 17 illustrates one example of an execution engine implementing some of the details of the system for the new instructions of FIG. 16A. For the indexed loads, the zero checking logic 170 checks to see whether the value of the index stored in a register, such as register H is 0. When the zero check enable is set (meaning that the instruction is one of the four instructions LDXNC, LWXNC, STXNC, or SWXNC), the zero check enable is set high. Note that the other operations for the load can be done concurrently with this operation. The zero checking logic 170 ensures that the pointer to the array is not 0, which would indicate a null value for the array pointer. When the pointer is correctly initialized, the value will not be a 0 and thus, when the value is a 0, an exception is created.

The adder/subtractor unit 172 produces a result and also produces the N, Z and C bits which are sent to the N, Z and C logic 174. For the bounds checking case, the bounds checking logic 176 checks to see whether the index is inside the size of the array. In the bounds checking, the index value is subtracted from the array size, the index value will be stored in one register, while the array value is stored in another register. If there is a carry, this indicates an exception, and the bounds check logic 176 produces an index out of range exception when the bounds checking is enabled.

Logical unit 178 includes the new logic 180. This new logic 180 implements the SGTLT0 and SGTLT0U instructions. Logic 180 uses the N and Z carry bits from a previous subtraction or add. As illustrated by FIGS. 16A and 16C, the logic 160 produces a 1, 0 or −1 value, which is then sent to the multiplexer (mux) 182. When the SGTLT0 or SGTLTU instructions are used, the value from the logic 180 is selected by the mux 182.

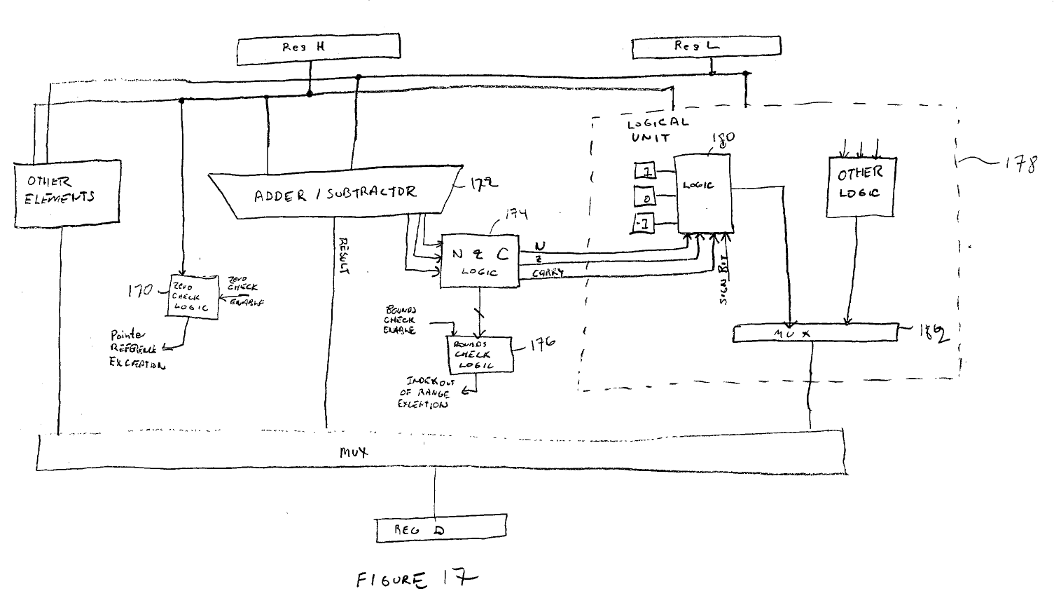

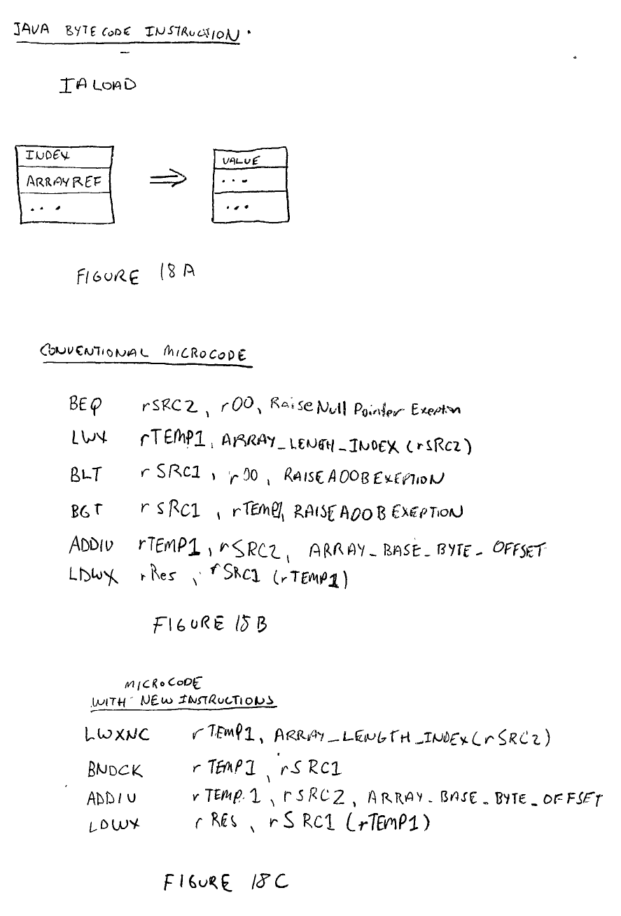

FIG. 18A illustrates the Java bytecode instruction IALOAD. The top two entries of the stack are an index and an array reference, which are converted to a single value indicated by the index offset into the array. With the conventional instructions as shown in FIG. 18B, the array reference needs to be compared to 0 to see whether a null pointer exception is to be produced. Next, a branch check is done to determine whether the index is outside of array bounds. The index value address is calculated and then loaded. In FIG. 18C, with the new instructions, the LWXNC reference does a zero check for the register containing the array pointer. The bounds check operation makes sure the index is within the array size. Thereafter the add to determine the address and the load is done.

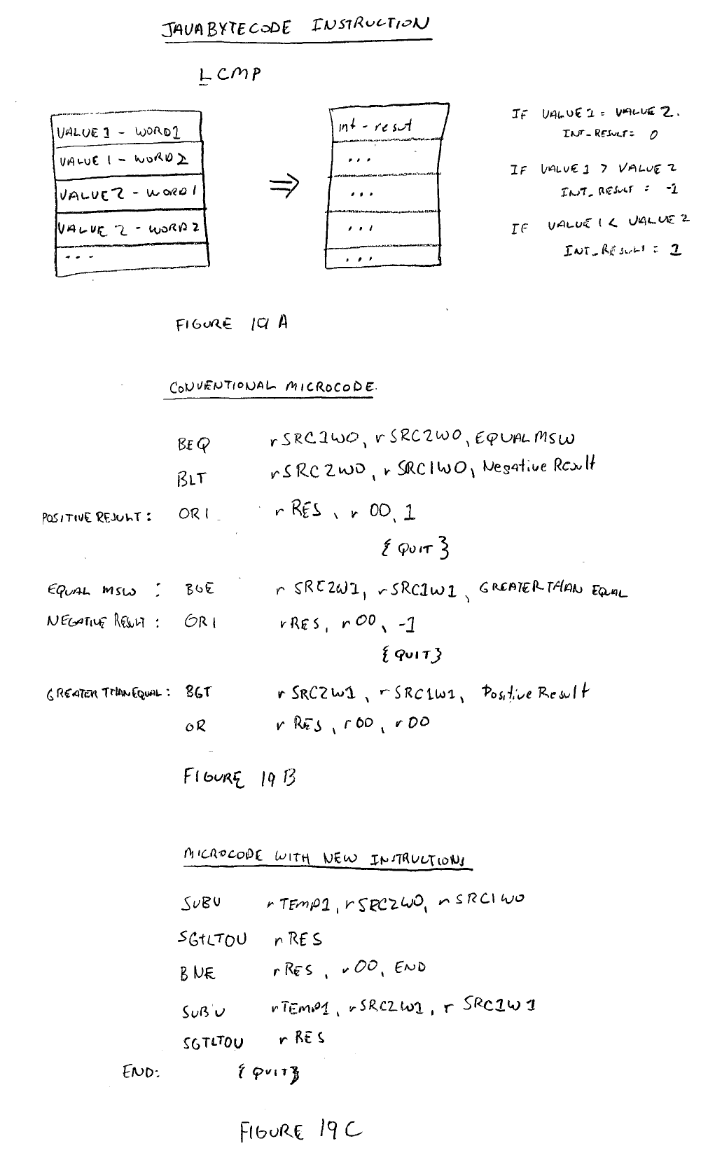

FIG. 19A illustrates the operation of an LCMP instruction, in which the top two values of the stack include two words for the first value. The second two values on the stack contain the value 1 word 1 and 2, and an integer result is produced based on whether value 1 is equal to value 2, value 1 is greater than value 2 or value 1 is less than value 2.

FIG. 19B illustrates a conventional instruction implementation of the Java LCMP instruction. Note that a large number of branches with the required time is needed.

In FIG. 19C, the existence of the SGLT0U instruction simplifies the operation of the code and can speed the system of the present invention.

The hardware translator is enabled to translate into the above new instructions. This makes the translation from Java bytecodes more efficient.

The Accelerator Chip of the present invention has a number of advantages. The Accelerator Chip directly accesses system memory to execute Java bytecode instructions while the host microprocessor services its interrupts, contributing to speed-up of Java software execution. Because the accelerator chip executes bytecodes and does not compile them, it does not impose additional memory requirements, making it a less costly and more efficient solution than using ahead-of-time (AOT) or just-in-time (JIT) compilation techniques. System level energy usage is minimized through a combination of faster execution time, reduced memory accesses and power management integrated within the accelerator chip. When not executing bytecodes, the Accelerator Chip is automatically in its power-saving sleep mode. The accelerator chip uses data localization and instruction level parallelism (ILP) optimizations achieve maximum performance. Data held locally within the accelerator chip preferably includes top entries on the Java stack and local variables that increase the effectiveness of the ILP optimizations and reduce accesses to system memory. These techniques result in fast and consistent execution and reduced system energy usage. This is in contrast to typical commercial microprocessors that rely on software interpretation that treat bytecodes as data and therefore derive little to no benefit from their instruction cache. Also, because Java bytecodes along with their associated operands vary in length a typical software bytecode interpreter must perform several data accesses from memory to complete each Java bytecode fetch cycle—a process that is inefficient in terms of performance and power consumption. The Java Virtual Machine (JVM) is a stack-based machine and most software interpreters locate the entire Java stack in system memory requiring several costly memory transactions to execute each Java bytecode instruction. As with bytecode fetches, the memory transactions required to manage and interact with a memory based Java stack are costly in terms of performance and increased system power consumption.

The Accelerator Chip easily interfaces directly to typical memory system designs and is fully transparent to all system software providing its benefits without requiring any porting or new development tools. Although the JVM is preferably modified to drive Java bytecode execution into the accelerator chip, all other system components and software are unaware of its presence. This allows any and all commercial development tools, operating systems and native application software to run as-is without any changes and without requiring any new tools or software. This also preserves the investment in operating system software, resident applications, debuggers, simulators or other development tools. Introduction of a accelerator chip is also transparent to memory accesses between the host microprocessor and the system memory but may introduce wait states. The Accelerator Chip is useful for mobile/wireless handsets, PDAs and other types of Internet Appliances where performance, device size, component cost, power consumption, ease of integration and time to market are critical design considerations.

In one embodiment, the accelerator chip is integrated as a chip stack with the processor chip. In another embodiment, the accelerator chip is on the same silicon as the memory. Alternatively, the accelerator chip is integrated as a chip stack with the memory. In a further embodiment, the processor chip is a system on a chip. In an alternative embodiment, the system on a chip is adapted for use in cellular phones.

In one embodiment, the accelerator chip supports execution of two or more intermediate languages, such as Java bytecodes and MSIL for C#/.NET.

In one embodiment of the present invention, the system comprises at least one memory, a processor chip operably connected to the at least one memory, and an accelerator chip, the accelerator chip operably connected to the at least one memory, memory access of the processor chip to the at least one memory being sent through the accelerator chip, the accelerator chip having direct access to the at least one memory, the accelerator chip being adapted to run at least portions of programs in an intermediate language, the hardware accelerator including a accelerator of a Java processor for the execution of intermediate language instructions.

In a further embodiment of the present invention, the system comprises at least one memory, a processor chip operably connected to the at least one memory, and an intermediate language accelerator chip, operably connected to the at least one memory, memory access of the processor chip to the at least one memory being sent through the accelerator chip, the accelerator chip having direct access to the at least one memory, the accelerator chip being adapted to run at least portions of programs in an intermediate language, wherein some instructions generate a callback and get executed on the processor chip.

The present application incorporates by reference application Ser. No. 09/208,741 filed Dec. 8, 1998; application Ser. No. 09/488,186 filed Jan. 20, 2000; application Ser. No. 60/239,298 filed Oct. 10, 2000; application Ser. No. 09/687,777 filed Oct. 13, 2000; application Ser. No. 09/866,508 filed May 25, 2001; application Ser. No. 60/302,891 filed Jul. 2, 2001; and application Ser. No. 09/938,886 filed Aug. 24, 2001.

While the present invention has been described with reference to the above embodiments, this description of the preferred embodiments and methods is not meant to be construed in a limiting sense. For example, the term Java in the specification or claims should be construed to cover successor programming languages or other programming languages using basic Java concepts (the use of generic instructions, such as bytecodes, to indicate the operation of a virtual machine). It should also be understood that all aspects of the present invention are not to be limited to the specific descriptions, or to configurations set forth herein. Some modifications in form and detail the various embodiments of the disclosed invention, as well as other variations in the present invention, will be apparent to a person skilled in the art upon reference to the present disclosure. It is therefore contemplated that the following claims will cover any such modifications or variations of the described embodiment as falling within the true spirit and scope of the present invention.

What is claimed is:

1. A system comprising:
at least one memory;
a processor chip operably connected to the at least one memory; and
an accelerator chip, the accelerator chip operably connected to the at least one memory, memory access of the processor chip to the at least one memory being sent through the accelerator chip, the accelerator chip having direct access to the at least one memory, the accelerator chip being adapted to run at least portions of programs in an intermediate language.

2. The system of claim 1 wherein the programs in an intermediate language instructions are Java bytecodes.

3. The system of claim 2 wherein the processor runs a modified Java virtual machine.

4. The system of claim 1 wherein the intermediate language is in bytecode form.

5. The system of claim 1 wherein the accelerator chip is positioned on a memory bus.

6. The system of claim 1 wherein the memory comprises a number of memory units.

7. The system of claim 6 wherein the memory units include a static random access memory.

8. The system of claim 6 wherein the memory units include a flash memory.

9. The system of claim 1 wherein the processor runs a modified virtual machine.

10. The system of claim 1 wherein the accelerator chip does not run certain bytecodes but instead has a callback to the virtual machine running on the processor chip.

11. The system of claim 1 wherein the accelerator chip has a sleep mode with low power consumption.

12. The system of claim 1 wherein the processor chip is a system on a chip.

13. The system of claim 1 wherein the accelerator chip includes a hardware translator unit adapted to convert intermediate language instructions into native instructions and an execution unit adapted to execute the native instructions provided by the hardware translator unit.

14. The system of claim 13 wherein the hardware translator unit is adapted to convert Java bytecodes into native instructions.

15. The system of claim 1 wherein the accelerator chip includes an interface adapted to allow memory access for the accelerator chip to at least one memory, and to allow for access for the processor chip to the at least one memory.

16. The system of claim 15 wherein the interface comprises a first interface to the processor chip and a second interface to the memory unit, the second and first interface adapted to operate independently.

17. The system of claim 1 wherein the accelerator chip includes an instruction cache operably connected to store instructions to be executed within the accelerator chip.

18. The system of claim 17 wherein the accelerator chip includes an instruction cache operably connected to store instructions to be executed within the accelerator chip.

19. The system of claim 1 wherein the accelerator chip includes a hardware translator unit and a dedicated execution unit adapted to execute native instructions provided by the hardware translator unit, the dedicated execution engine only executing instructions provided by the hardware translator unit.

20. The system of claim 1 wherein the accelerator chip is integrated as a chip stack with the processor chip.

21. The system of claim 1 wherein the accelerator chip is on the same silicon as the memory.

22. The system of claim 1 wherein the accelerator chip is integrated as a chip stack with the memory.

23. The system of claim 1 wherein the processor chip is a system on a chip.

24. The system of claim 23 wherein the system on a chip is adapted for use in cellular phones.

25. The system of claim 1 wherein the accelerator chip supports execution of two or more intermediate languages.

26. The system of claim 25 wherein the intermediate languages are Java bytecodes and MSIL for C#/.NET.

27. A system comprising:
at least one memory;
a processor chip operably connected to the at least one memory; and
a accelerator chip, the accelerator chip operably connected to the at least one memory, memory access of the processor chip to the at least one memory being sent through the accelerator chip, the accelerator chip having direct access to the at least one memory, the accelerator chip being adapted to run at least portions of programs in an intermediate language, the hardware accelerator including a hardware translator unit adapted to covert intermediate language instructions into native instructions, and an execution engine adapted to execute the native instructions provided by the hardware translator unit.

28. The system of claim 27 wherein the programs in an intermediate instruction language are Java programs and the hardware translator unit coverts Java bytecodes into native instructions.

29. The system of claim 28 wherein the processor runs a modified Java virtual machine.

30. The system of claim 27 wherein the accelerator chip is positioned on a memory bus in between the processor chip and the at least one memory.

31. The system of claim 27 wherein the memory comprises a number of memory units.

32. The system of claim 31 wherein one of the memory units comprises a static random access memory.

33. The system of claim 31 wherein at least one of the memory units comprises a flash memory.

34. The system of claim 27 wherein the processor runs a modified virtual machine.

35. The system of claim 34 wherein the accelerator chip does not execute certain intermediate language instructions and a callback occurs when these intermediate language instructions occur, these intermediate language instructions being executed on the modified virtual machine running on the processor chip.

36. The system of claim 27 wherein the accelerator chip has a sleep mode with low power consumption.

37. The system of claim 27 wherein the processor chip is a system on a chip.

38. The system of claim 27 wherein the accelerator chip includes an interface adapted to allow for memory access for the accelerator chip to at least one memory, and to allow for memory access for the processor chip to the at least one memory.

39. The system of claim 27 wherein the accelerator chip further includes an instruction cache operably connected to the hardware translator unit storing the intermediate language instructions to be converted.

40. The system of claim 27 wherein the execution engine is a dedicated execution engine only executing instructions provided by the hardware translator unit.

41. An accelerator chip comprising:
a unit adapted to execute intermediate language instructions; and
an interface, the interface adapted to allow for memory access for the accelerator chip to at least one memory and to allow for memory access for a separate processor chip to the at least one memory.

42. The accelerator chip of claim 41 wherein the intermediate language instructions are Java bytecodes.

43. The accelerator chip of claim 41 wherein the accelerator chip does not execute certain intermediate language instructions but instead causes a callback to the separate processor chip.

44. The accelerator chip of claim 41 wherein the accelerator chip has a sleep mode with low power consumption.

45. The accelerator chip of claim 41 wherein the accelerator chip includes an instruction cache operably connected to operably connected to the hardware translator unit storing intermediate language instructions to be converted.

46. The accelerator chip of claim 41 wherein the unit includes a hardware translator unit adapted to convert intermediate language instructions into native instructions and an execution engine adapted to execute native instructions provided by the hardware translator unit.

47. The accelerator chip of claim 41 wherein the unit comprises a dedicated processor whose native instruction is the intermediate language instruction.

48. An accelerator chip comprising:
a hardware translator unit adapted to covert intermediate language instructions into native instructions;
an execution engine adapted to execute the native instructions provided by the hardware translator unit; and
an interface, the interface adapted to allow for memory access for the accelerator chip to at least one memory and to allow for memory access for a separate processor chip to the at least one memory.

49. The accelerator chip of claim 48 wherein the intermediate language instructions are Java bytecodes.

50. The accelerator chip of claim 48 wherein the accelerator chip does not execute every intermediate language instruction but some intermediate language instructions cause a callback to the separate processor chip running a modified virtual machine.

51. The accelerator chip of claim 48 wherein the accelerator chip has a sleep mode with low power consumption.

52. The accelerator chip of claim 48 wherein the accelerator chip further includes an instruction cache operably connected to the hardware translator unit storing intermediate language instructions to be converted.

53. The accelerator chip of claim 48 wherein the execution engine is a dedicated execution engine only executing instructions provided by the hardware translator unit.

54. An accelerator chip comprising:
a hardware translator unit adapted to covert intermediate language instructions into native instructions;
an instruction cache operably connected to the hardware translator unit storing intermediate language instructions to be converted;
an execution engine adapted to execute the native instructions provided by the hardware translator unit; and
an interface, the interface adapted to allow for memory access for the accelerator chip to at least one memory and to allow for memory access for a separate processor chip to the at least one memory.

55. The accelerator chip of claim 47 wherein the intermediate language instructions are Java bytecodes.

56. The accelerator chip of claim 54 wherein the accelerator chip does not execute every intermediate language instruction but for some intermediate language instructions causes a callback to a processor running a modified virtual machine.

57. The accelerator chip of claim 54 wherein the accelerator chip has a sleep mode with low power consumption.

58. The accelerator chip of claim 54 wherein the execution engine is a dedicated execution engine adapted to only execute instructions provided by the hardware translator unit.

59. An accelerator chip comprising:
a hardware translator unit adapted to covert intermediate language instructions into native instructions; and
a dedicated execution engine adapted to execute the native instructions provided by the hardware translator unit, the dedicated execution engine only executing instructions provided by the hardware translator unit, wherein the hardware translator unit, rather than the execution engine, determines the address of the next intermediate language instruction to translate and provide to the dedicated execution engine.

60. The accelerator chip of claim 59 wherein the intermediate language instructions are Java bytecodes.

61. The accelerator chip of claim 59 wherein the accelerator chip does not execute every intermediate language instruction but some intermediate language instructions cause a callback to a separate processor chip running a modified virtual machine for interpretation.

62. The accelerator chip of claim 59 wherein the accelerator chip includes a sleep mode with low power consumption.

63. The accelerator chip of claim 59 wherein the accelerator chip includes an interface adapted to allow for memory access for the accelerator chip to at least one memory and allow for memory access for a separate processor chip to the at least one memory.

64. The accelerator chip of claim 59 wherein the accelerator chip further includes an instruction cache operably connected to the hardware translator unit storing intermediate language instructions to be converted.

65. A method of operating an accelerator chip comprising:
in a hardware translator unit, calculating the address of intermediate language instructions to execute;
obtaining the intermediate language instructions from a memory;
in the hardware translator unit, converting the intermediate language instructions to native instructions;
providing the native instructions to an execution engine; and
in the execution engine, executing the native instructions, wherein for at least one intermediate language instruction a callback to a separate processor chip running a virtual machine is done to handle the intermediate language instruction.

66. The method of claim 65 wherein the intermediate language instructions are Java bytecodes.

67. An accelerator chip comprising:
a hardware translator unit adapted to covert intermediate language instructions into native instructions;
an execution engine adapted to execute the native instructions provided by the hardware translator unit;
an interface, the interface adapted to allow for memory access for the accelerator chip to at least one memory and to allow for memory access for a separate processor chip to the at least one memory; and
a graphics acceleration engine adapted to be interconnected to a display, the graphics acceleration engine executing intermediate language instructions concerning a display.

68. The accelerator chip of claim 67 wherein the intermediate language instructions are Java bytecodes.

69. The accelerator chip of claim 68 wherein Java based libraries are used.

70. The system of claim 69 wherein the Java based libraries include Java based programs.

71. The system of claim 70 wherein the Java based programs are modified Java programs.

72. The accelerator chip of claim 67 in which the display is an LCD display and the graphics acceleration engine implements an LCD display.

73. The accelerator chip of claim 72 wherein the graphics acceleration engine implements a Java LCD display library function.

74. A system comprising:
a hardware translator unit adapted to covert intermediate language instructions into native instructions; and
an execution engine adapted to execute the native instructions provided by the hardware translator unit, the execution engine including at least one indexed instruction to do an indexed load from or store into an array, the instruction concurrently checking a first register storing an array pointer to see whether it is null.

75. The system of claim 74 wherein the hardware translator unit and the execution engine are positioned on an accelerator chip.

76. The system of claim 74 wherein the accelerator chip is positioned between a processor chip and a memory.

77. The system of claim 74 wherein the intermediate language instructions are Java instructions.

78. The system of claim 74 wherein the hardware translator unit translates some array loading and array storing instructions so as to use at least one index instruction.

79. A system comprising:
a hardware translator unit adapted to covert intermediate language instructions into native instructions; and
an execution engine adapted to execute the native instructions provided by the hardware translator unit, the execution engine including at least one indexed instruction to do an indexed load from or store into an array, the execution engine having a zero checking unit adapted to check whether a first register storing an array pointer to see whether it is null, the null checking unit of the execution engine working concurrently with portions of the execution engine doing the indexed load from or store into an array.

80. The system of claim 79 in which the intermediate language instructions are Java bytecodes.

81. The system of claim 79 in which the hardware translator unit and execution engine are on an accelerator chip.

82. An system comprising:
a hardware translator unit adapted to covert intermediate language instructions into native instructions; and
an execution engine adapted to execute the native instructions provided by the hardware translator unit, the execution engine including at least one bounds checking instruction, the bounds checking instruction ensuring that an index value stored in a first register is less than or equal to an array length value stored in a second register.

83. The system of claim 82 wherein the intermediate language instructions are Java bytecodes.

84. The system of claim 82 in which the hardware translator unit and execution engine are part of an accelerator chip.

85. The system of claim 84 in which the accelerator chip is positioned between a processor chip and a memory.

86. An system comprising:
a hardware translator unit adapted to covert intermediate language instructions into native instructions; and
an execution engine adapted to execute the native instructions provided by the hardware translator unit, the execution engine including an instruction that based on values from the last addition or subtraction stores an 1, 0, or −1 in a register.

87. The system of claim 86 wherein the values include the N, Z and carry bits.

88. The system of claim 86 wherein the signed instruction checks the Z and the N bits. If the Z bit is high, a 0 is put in the register. If the Z bit is low and N is low, 1 is put in the register. If the Z bit is low and N is high, a −1 is put in the register.

89. The system of claim 86 in which an unsigned instruction check is done to check the Z and C bits. If the Z bit is high, a 0 is put in the register. If the Z bit is low, and C is high, 1 is put in the register. If the Z bit is low and the C is low, −1 is put in the register.

90. The system of claim 86 in which both signed and unsigned checks are done.

91. The system of claim 86 wherein the hardware translator unit and execution engine are on an accelerator chip.

92. A system comprising:
at least one memory;
a processor chip operably connected to the at least one memory; and
an accelerator chip, the accelerator chip operably connected to the at least one memory, memory access of the processor chip to the at least one memory being sent through the accelerator chip, the accelerator chip having direct access to the at least one memory, the accelerator chip being adapted to run at least portions of programs in an intermediate language, the hardware accelerator including a accelerator of a Java processor for the execution of intermediate language instructions.

93. A system comprising:
at least one memory;
a processor chip operably connected to the at least one memory; and
an intermediate language accelerator chip, operably connected to the at least one memory, memory access of the processor chip to the at least one memory being sent through the accelerator chip, the accelerator chip having direct access to the at least one memory, the accelerator chip being adapted to run at least portions of programs in an intermediate language, wherein some instructions generate a callback and get executed on the processor chip.

94. The system of claim 93 wherein a system of registers is used for transferring information between the SoC and accelerator for callbacks.

95. A system comprising:
at least one memory;
a processor chip operably connected to the at least one memory; and
an intermediate language accelerator chip, operably connected to the at least one memory, memory access of the processor chip to the at least one memory being sent through the accelerator chip, the accelerator chip having direct access to the at least one memory, wherein the use of the accelerator chip is in a cell phone or mobile handheld device.

96. A system comprising:
at least one memory;
a processor chip operably connected to the at least one memory; and
an intermediate language accelerator chip, operably connected to the at least one memory, memory access of the processor chip to the at least one memory being sent through the accelerator chip, the accelerator chip having direct access to the at least one memory wherein the accelerator is stacked on the SoC in the same package

97. System of claim 96 wherein the use of the accelerator chip is in a cell phone or mobile handheld device.

98. A system comprising:
at least one memory;
a processor chip operably connected to the at least one memory; and an intermediate language accelerator chip, operably connected to the at least one memory, memory access of the processor chip to the at least one memory being sent through the accelerator chip, the accelerator chip having direct access to the at least one memory wherein the accelerator is stacked with one or more memory in the same package.

99. System of claim 98 wherein the use of the accelerator chip is in a cell phone or mobile handheld device.
